(19) United States
(12) Patent Application Publication
(10) Pub. No.: US 2021/0329858 A1
(43) Pub. Date: Oct. 28, 2021

(54) STUMP GRINDING WOOD CHIP COLLECTION SYSTEM

(71) Applicant: Leonardi Manufacturing Co., Inc., Weedsport, NY (US)

(72) Inventors: Joseph A. Leonardi, Auburn, NY (US); Bruce C. Jordan, Auburn, NY (US)

(73) Assignee: Leonardi Manufacturing Co., Inc., Weedsport, NY (US)

(21) Appl. No.: 17/264,582

(22) PCT Filed: Aug. 5, 2019
(86) PCT No.: PCT/US19/45154

§ 371 Date: Jan. 29, 2021

Related U.S. Application Data
(60) Provisional application No. 62/714,373, filed on Aug. 3, 2018.

(51) Int. Cl. A01G 23/06; B27L 11/00

(52) U.S. Cl. CPC A01G 23/067; B27L 11/005; B27L 11/002

(57) ABSTRACT

A wood chip collection system having a stump grinding wheel, a chip chute and a chip collection bin. The chute is positioned such that chips generated by the rotation of the wheel when engaged in a stump will be directed into the chute. The chute, in turn is sized and shaped to permit the energy in the chips to move the chips into a collection bin. The bin is positioned adjacent to and in alignment with the trailing edge of the chute in order to effectively receive the chips.

### CROSS-REFERENCE TO RELATED APPLICATION

This application relates and claims priority to U.S. Provisional Patent Application Ser. No. 62/714,373, filed Aug. 3, 2018, and entitled “STUMP GRINDING WOOD CHIP COLLECTION SYSTEM”, and relates to International Application No. PCT/US18/58393, filed Oct. 31, 2018, which claims priority to U.S. Provisional Application No. 62/579,656, filed on Oct. 31, 2017, and entitled “STUMP GRINDER CHIP CHUTE DEVICE AND SYSTEM,” and also relates to U.S. Non-Provisional application Ser. No. 16/188,378, filed on Nov. 13, 2018, and entitled “STUMP GRINDER CHIP PICKUP CHUTE DEVICE AND COLLECTION SYSTEM,” which claims priority to U.S. Provisional Application No. 62/584,612, filed on Nov. 10, 2017, and entitled “STUMP GRINDER CHIP PICKUP CHUTE DEVICE AND COLLECTION SYSTEM,” the entire disclosure of each of which is incorporated herein by reference.

### FIELD OF THE INVENTION

The present disclosure is directed generally to stump grinding and more particularly to a stump grinding system having a chip chute and chip collection bin.

### BACKGROUND

Stump grinders are well known in the art. Typically, stump grinders employ a wheel to which a plurality of cutting teeth are mounted about the wheel's periphery. The wheel rotates about its axis at a high rate of speed and is driven by a motor. As the wheel rotates, the teeth impact a stump, chipping away the wood. As the teeth cut the stump into small chips and do so at high rates of speed, the chips generally get thrown and collect in a large pile to the side of or behind the stump grinder. In large stump removal projects, these chip piles can accumulate rapidly and require significant clean-up efforts.

Various conventional stump grinders with chip guard devices/systems exist. For example, the Carlton SP5014 TRX Series Track-Mounted Stump Cutter includes a chip guard. However, the chip guard of this stump cutter is only configured to partially contain the cut chips and stones in the working/cutting area and prevent the cut chips from spreading too far from the cut area, and end up recutting and regrinding the chips. The chips cut by this stump cutter (and all other conventional stump cutters with chip guard devices/systems) cannot be captured and controlled/directed to a desired chip collection location.

Accordingly, there is a need in the art for a system that collects the chips as they are produced.

Description of the Related Art Section Disclaimer: To the extent that specific patents/publications/products are discussed above in this Background Section or elsewhere in this application, these discussions should not be taken as an admission that the discussed patents/publications/products are prior art for patent law purposes. For example, some or all of the discussed patents/publications/products may not be sufficiently early in time, may not reflect subject matter developed early enough in time and/or may not be sufficiently enabling so as to amount to prior art for patent law purposes. To the extent that specific patents/publications/products are discussed above in this Background Section and/or throughout the application, the descriptions/disclosures of which are all hereby incorporated by reference into this document in their respective entirety(ies).

### SUMMARY

The present disclosure is directed to a stump grinding wood chip collection system.

According to an aspect is a wood chip collection system for use with a stump grinder having a stump grinding wheel used to break a tree stump into wood chips, comprising: a chassis to which the stump grinder wheel is interconnected; and a collection bin positioned adjacent to the chassis and having an open end that is adapted to receive chips therethrough.

According to an embodiment, the wood chip collection system further comprises a rod extending between the collection bin and chassis and actuable to pivotally move the collection bin between a chip collection position and a chip dumping position.

According to an embodiment, the wood chip collection system further comprises a chute connected to the chassis in spaced relation to the stump grinding wheel and having a trailing edge, the chute being positioned to receive wood chips as the stump grinding wheel impacts a tree stump.

According to an embodiment, the chute of the wood chip collection system is pivotally connected to the chassis.

According to an embodiment, the collection bin of the wood chip collection system is pivotally connected to the chassis.

These and other aspects of the invention will be apparent from the embodiments described below.

### BRIEF DESCRIPTION OF THE DRAWINGS

The present invention will be more fully understood and appreciated by reading the following Detailed Description in conjunction with the accompanying drawings, in which:

FIG. 1 is a perspective view of a wood chip collection system, in accordance with an embodiment.

FIG. 2 is a side elevation view of a wood chip collection system, in accordance with an embodiment.

FIG. 3 is a side elevation view of a wood chip collection system, in accordance with an embodiment.

FIG. 4 is a perspective view of a wood chip collection system, in accordance with an embodiment.

FIG. 5 is a perspective view of a wood chip collection system, in accordance with an embodiment.

FIG. 6 is a perspective view of a wood chip collection system, in accordance with an embodiment.

FIG. 7 is a side elevation view of a wood chip collection system, in accordance with an embodiment.

FIG. 8 is a perspective view of a wood chip collection system, in accordance with an embodiment.

FIGS. 9A-9H are schematic views of components to a wood chip collection system, in accordance with an embodiment.

FIGS. 10A-10F are schematic views of components to a wood chip collection system, in accordance with an embodiment.

FIGS. 11A-11D are schematic views of components to a wood chip collection system, in accordance with an embodiment.

FIG. 12 is a digital photograph of a component to a wood chip collection system, in accordance with an embodiment.

FIG. 13 is a digital photograph of a component to a wood chip collection system, in accordance with an embodiment.

FIGS. 14A-14G are schematic views of components to a wood chip collection system, in accordance with an embodiment.

FIG. 15 is a digital photograph of a component to a wood chip collection system, in accordance with an embodiment.

### DETAILED DESCRIPTION OF EMBODIMENTS

The present disclosure describes a wood chip collection system. A stump grinding mechanism with stump cutting/grinding wheel and a guard or chip chute are described and shown herein, among other things (which can include any stump cutting/grinding wheel with various stump cutting tooth assemblies, as should be understood by those of skill in the art, including, for example, the stump cutting tooth assembly and stump cutting wheel (with or without a chip chute system) shown and described in U.S. Pat. Nos. 8,584,717, 6,382,277, and/or in applicant's co-pending application PCT/US18/58393). In addition, aspects of applicant's related co-pending application U.S. application Ser. No. 16/188,378 (which is directed to stump grinder chip pickup chute devices and collection systems for capturing and controlling chips cut from a stump by a stump grinding/cutting wheel, and redirecting the chips to a desired target chip collection location), include aspects which can be useful and complimentary to this disclosure, as should be understood by a person of ordinary skill in the art in conjunction with a review of this disclosure.

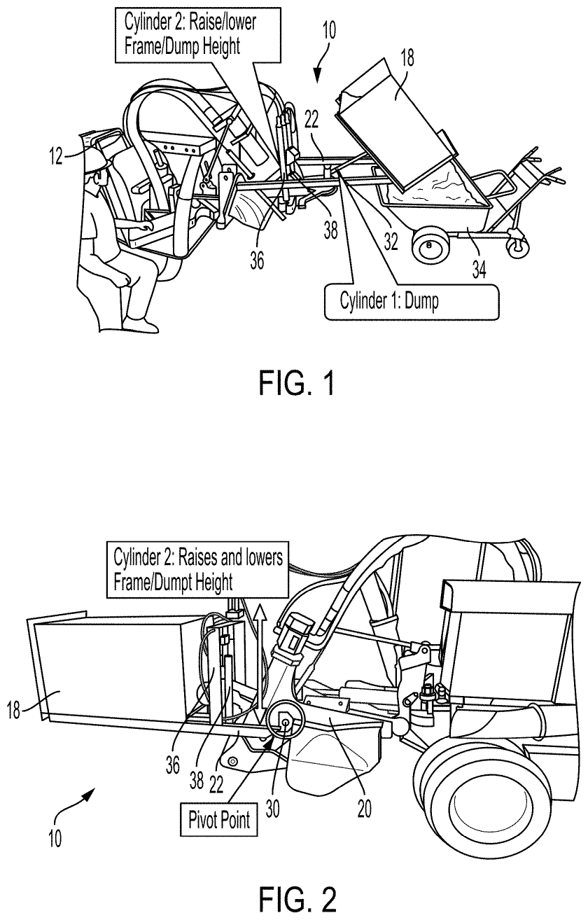

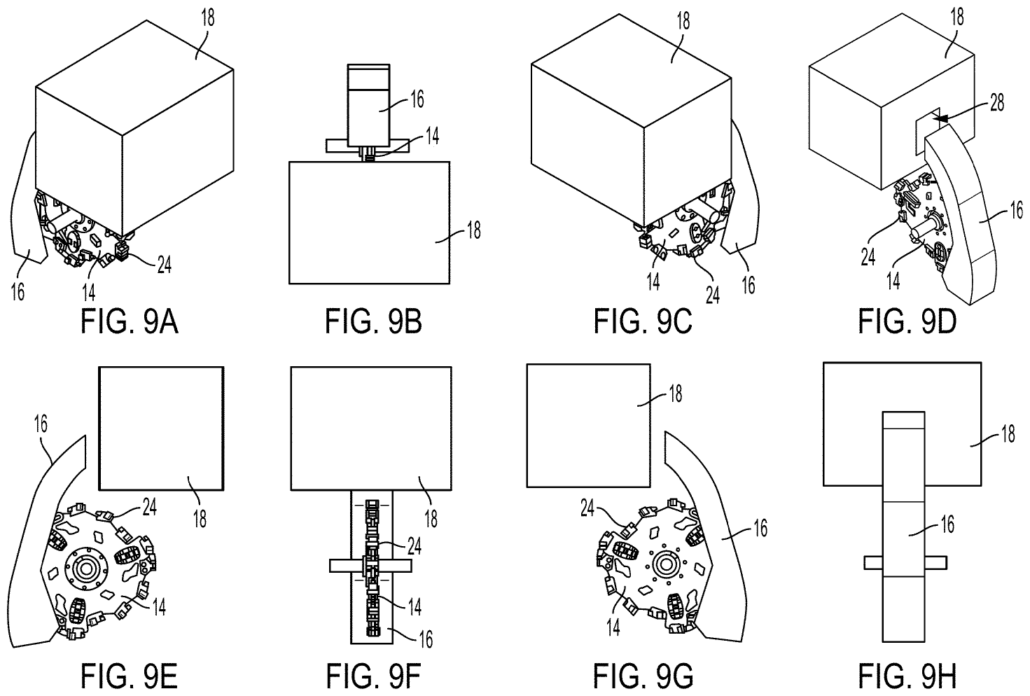

Referring to FIG. 1, in one embodiment, is a wood chip collection system, designated generally by reference numeral 10, generally comprising a stump grinder 12 having a stump grinding wheel 14, a chute 16 for directing chips created by wheel 14 (and the teeth on the wheel when impacting a stump), and a collection bin 18 into which chips are disposed during the grinding operation. A chassis 20 provides the framework to which the wheel 14, chute 16, and bin 18 are all preferably interconnected. In one embodiment, a pair of elongated rails 22 extend off of chassis 20 and bin 18 is attached to rails 22. In normal operation without system 10, as wheel 14 is driven and its teeth 24 (see, e.g., FIGS. 9A, 9C-G, 10A-F) engage a stump 26 (see, e.g., FIG. 26), they create wood chips that are pushed by the tooth; due to the high rate of speed of wheel 14 the chips normally will be thrown a significant distance and due to the large amount of chips generated when grinding stump 26, the amount of chip debris can be significant. With system 10, the chips are directed into chute 16 which is mounted in a position to receive the chips as they are thrown by wheel 14/teeth 24, and chute 16, in turn, directs the chips through an opening 28 formed in the top of bin 18.

Chute 16 is formed as a partially enclosed tubular structure that curves along its length so as to facilitate the movement of chips therealong; further details of chute 16 are provided in applicant's co-pending application PCT/US18/58393, the entirety of which is hereby incorporated by reference. The energy of the chips when thrown off of wheel 14/teeth 24 is significant enough to maintain movement of the chips entirely through the chute 16 and into bin 18.

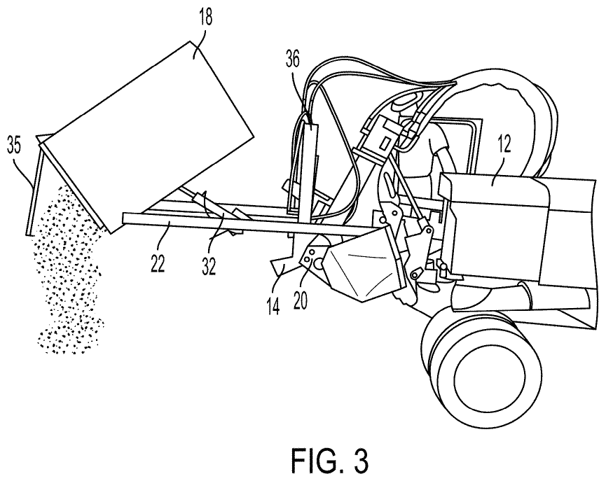

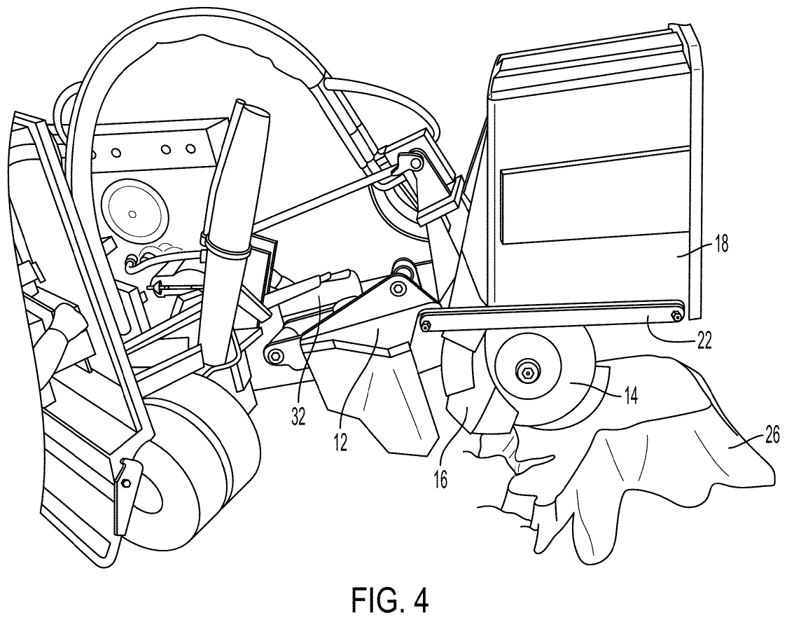

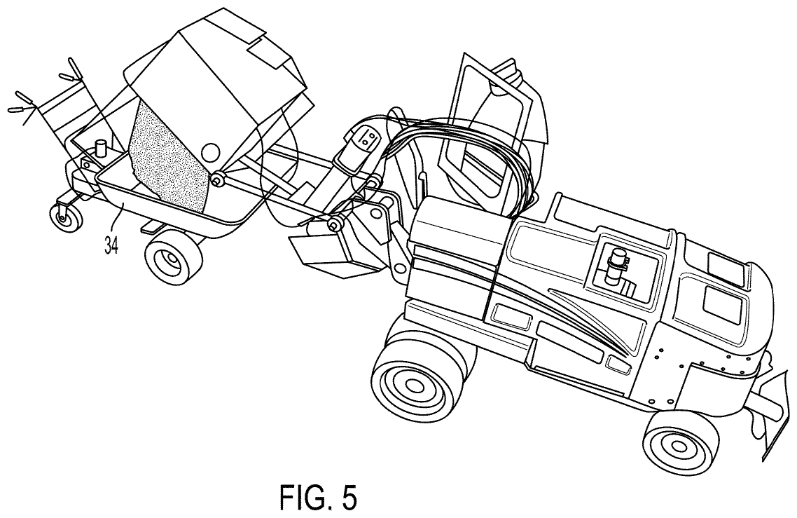

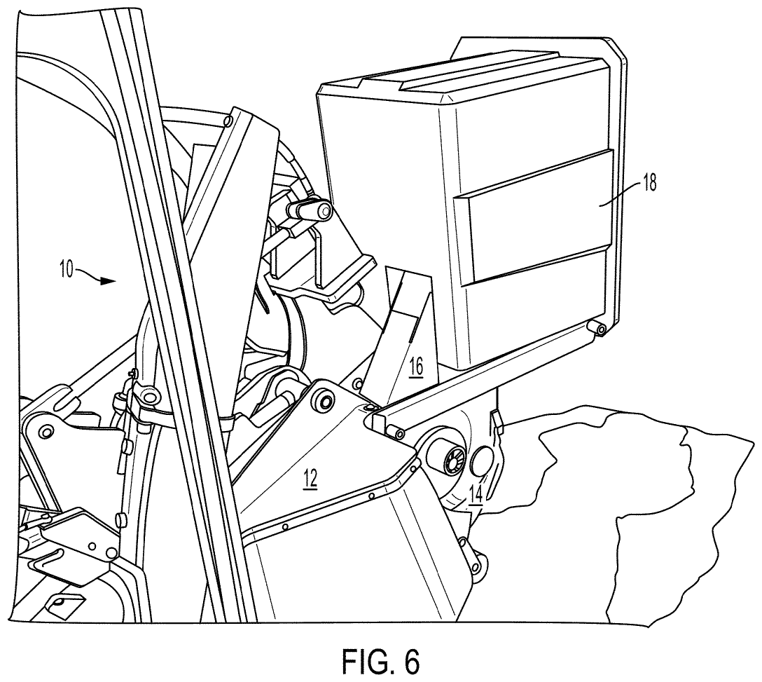

In one embodiment, bin 18 is connected to rails 22 which in turn connect to chassis 20. In one embodiment, bin 18 is pivotally movable relative to chassis 20 by having rails 22 pivotally connect to chassis 20 by fasteners 30 that permit the pivotal movement. A first cylinder 32 extends from rails 22 to bin 18 and is automatically extendable to pivotally move bin 18 in order to tilt bin 18 causing it to dump the chips into a collection area. In the embodiment of FIG. 1, a wheelbarrow 34 is placed in the collection area and chips are dumped into the wheelbarrow for movement to a final dumping site. A door 35 (see, e.g., FIG. 3) is hingedly connected to the bottom end of bin 18 and will open when placed in the dumping position and remain closed when not in dumping position (via spring or other bias element).

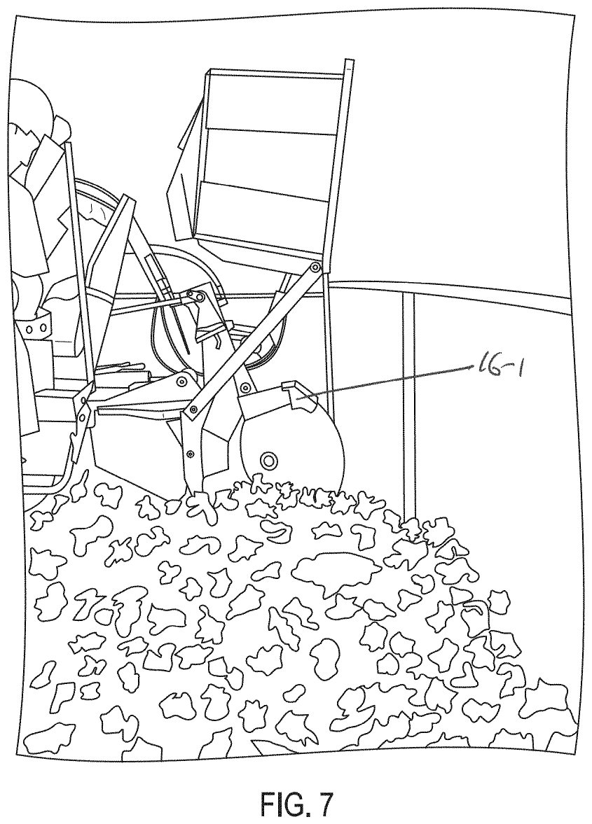

Bin 18 may also be raised and lowered to accommodate different dumping heights. As seen in FIG. 2, a U-shaped frame 36 attaches to rails 22 and extends in an essentially vertical plane. A second cylinder 38 extends between chassis 20 and frame 34 and is extendable to raise/lower rails 22 and bin 18. This permits the system to be raised and lowered to accommodate different dumping heights, as exemplified and seen in FIG. 7. FIG. 7 also shows an alternative discharge chute with a distal end portion 16-1. It can adjust vertically at the end of the chute where it throws the material (via any electromechanical means, as should be understood by a person of ordinary skill in the art in conjunction with a review of this disclosure).

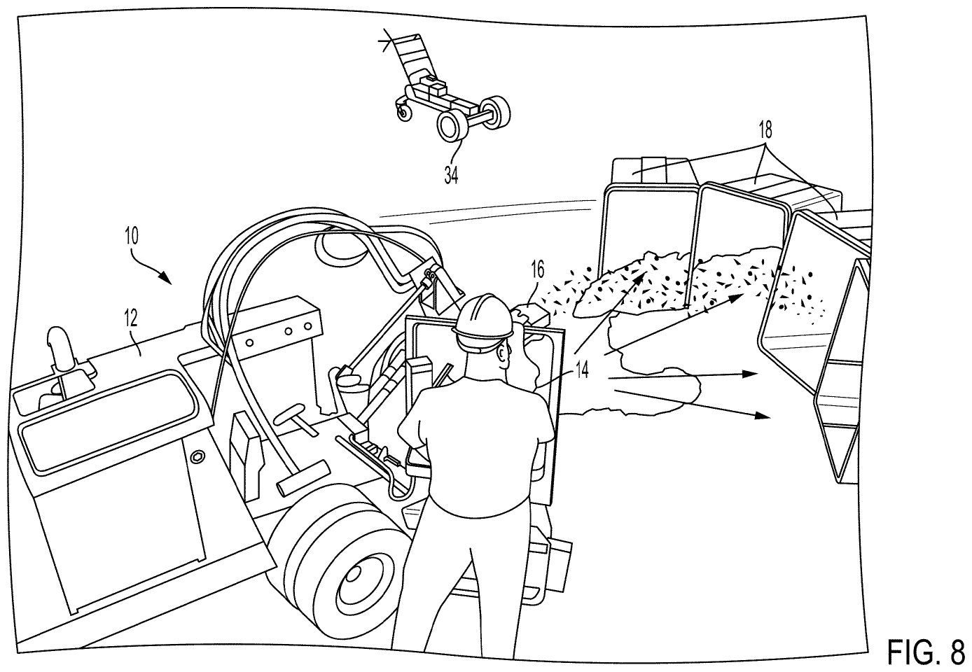

With reference to FIG. 8, system 10 can be set up with a series of collection bins 18 disconnected from but positioned adjacent stump grinder 12. Due to the energy in the chips as they are thrown by wheel 14, chute 16 can be positioned to further throw the chips into a series of bins 18 that are placed with open sides facing the direction from which the chips would be thrown. By having a series of bins 18 (preferably arranged in a curved pattern) that align with the orientation of wheel 14 as it sweeps across a stump, the chips can be collected in the bins. A wheelbarrow or cart 34 can be used to pick up and move the bins 18 when they become full of chips.

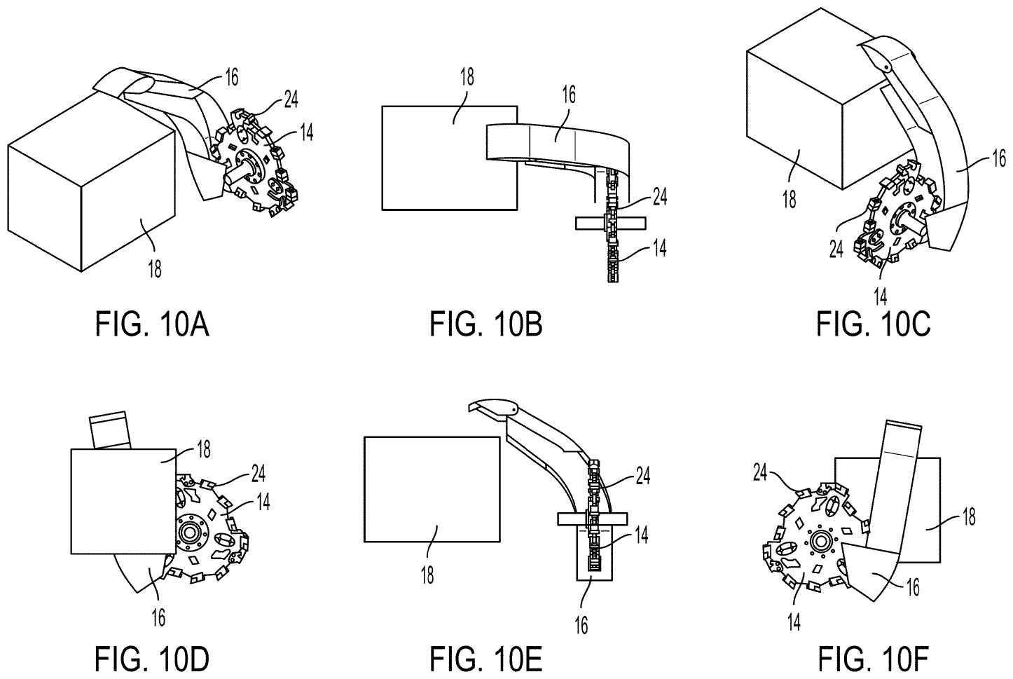

With reference to FIGS. 9A-9H, the arrangement of the wheel 14, chute 16 and bin 18 can be such that bin 18 is positioned in alignment with chute 16. With reference to FIGS. 10A-10F, the arrangement can be with bins 18 positioned to the left (or right) of the trailing edge of chute 16. The arrangements can be varied based upon the type of stump grinder being employed and the area in which the stump is being ground and those space constraints.

While various embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

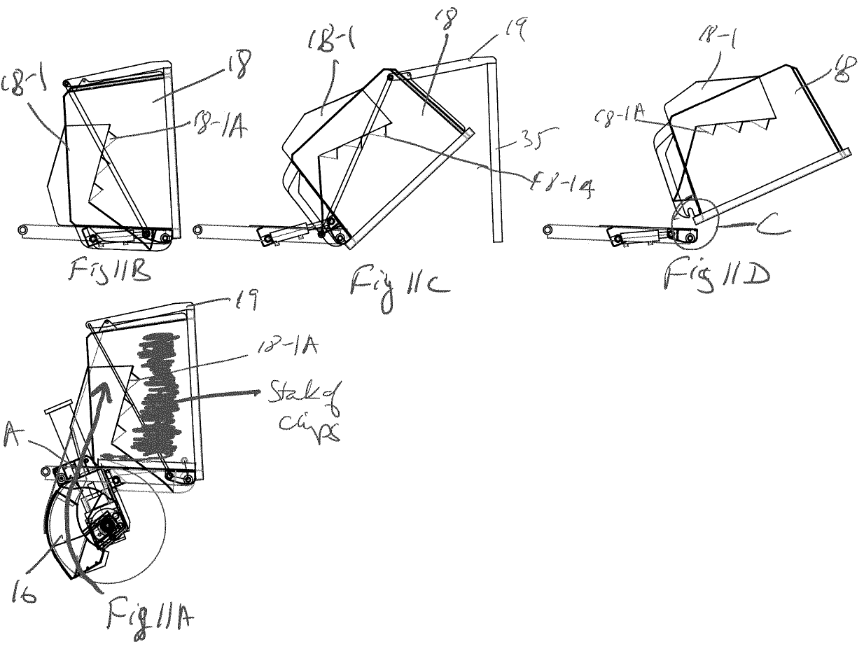

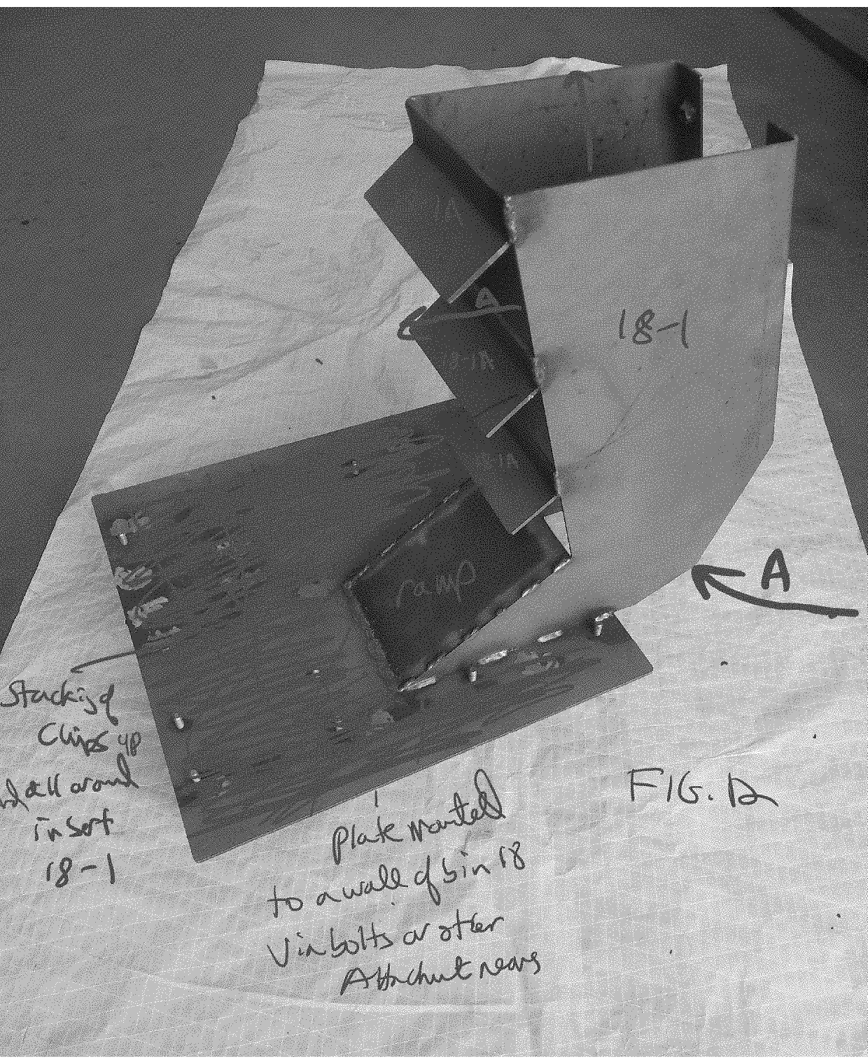

Turning to FIGS. 11A-D, schematic views of components to a wood chip collection system, in accordance with an embodiment, are shown. In particular, an insert 18-1 is shown positioned within bin 18 (preferably fixed to a wall of the bin 18 as shown in these FIGS. and in FIG. 12 and moves with the bin 18 as shown in FIGS. 11B-D, but can also move with respect to the bin 18 in an alternative embodiment via any electromechanical means, as should be understood by a person of ordinary skill in the art). This insert 18-1 assists with the flow and stacking of chip material that flows into the bin 18 via chute 16 as shown by arrow A. The preferable flow and stacking of chips (shown in FIG. 11A) is possible via the baffles 18-1A (which can include at least one or more—three are shown). The baffles are preferably angled (but do not have to be, as shown more clearly in FIG. 12) to assist with this flow and stacking of chips, and if multiple baffles 18-1, some can be angled and others don't have to be, can be at different angles, or can be at the same angles with respect to the mounting plate shown most clearly in FIG. 12. Linkage arm 19 is also shown (can be multiple or a single linkage arm 19), which allows door 35 to automatically open when dumped or tipped (which could be done mechanically, electro-mechanically, using hydraulics, etc.). This is another embodiment that makes the door 35 pull up and out of the way better and faster. FIG. 11D shows a quick release mechanism for removal of bin and insert from the machine. This can be done via a notch as shown in circle C or other similar mechanical means. A discharge shoot can then be added (like in current FIG. 7) for tight spaces or to put on the steerable head (FIG. 8) to convert to throw forward version (see, e.g., PCT/US18/58393). FIG. 13 shows the bottom of the bin 18 with insert 18-1 positioned therein.

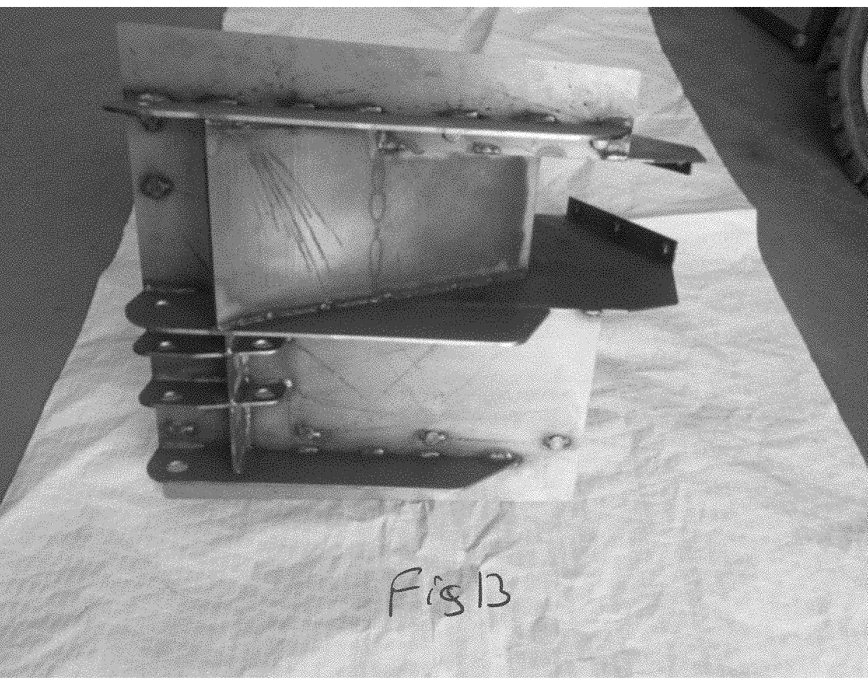

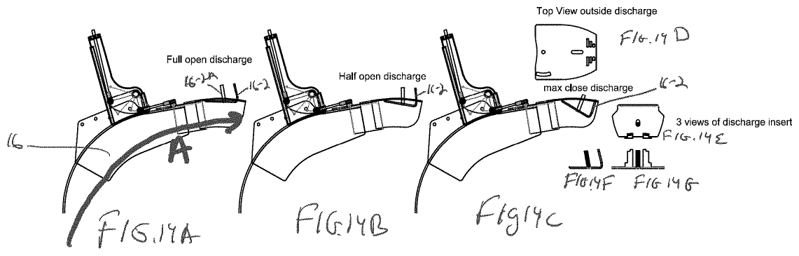

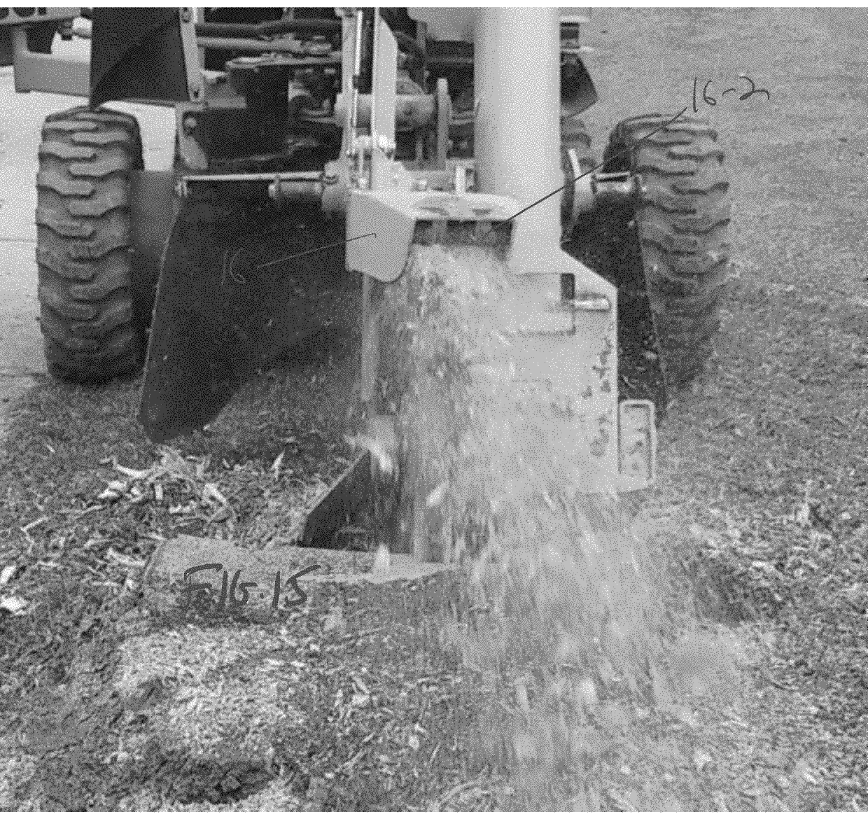

Turning to FIGS. 14A-G, schematic views of components to a wood chip collection system, in accordance with an embodiment, are shown. FIGS. 14A-C show a chip chute 16 with a discharge deflector 16-2 positioned therein (preferably at within the distal end). The discharge deflector can move between a fully open discharge position (FIG. 14A), to a half open discharge position (FIG. 14B), and to a max close discharge position (FIG. 14C)—and any positions in between via any electromechanical means as should be understood by a person of ordinary skill in the art in conjunction with a review of this disclosure (e.g., via bolt 16-2A or other electro/mechanical means). These different positions of the discharge deflector will affect the flow/direction of chips (see arrow A) out of the chute 16 accordingly. FIGS. 14D-G show various views of the discharge deflector 16-2. FIG. 15 is a picture of a machine with a discharge deflector 16-2 positioned within chute 16 in use. Vertical and horizontal movement of the discharge deflector 16-2 is contemplated.

As shown and discussed herein, a bin mounted on a machine that pivots, lifts, dumps with automatic opening door has been disclosed (among other things), which can easily be removed from a machine and converted to a short version for tight places or back to the throw forward version in as shown and described in PCT/US18/58393, for example.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto; inventive embodiments may be practiced otherwise than as specifically described and claimed.

All references, including publications, patent applications, and patents, cited herein are hereby incorporated by reference to the same extent as if each reference were individually and specifically indicated to be incorporated by reference and were set forth in its entirety herein.

All definitions, as defined and used herein, should be understood to control over dictionary definitions, definitions in documents incorporated by reference, and/or ordinary meanings of the defined terms.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

Approximating language, as used herein throughout the specification and claims, may be applied to modify any quantitative representation that could permissibly vary without resulting in a change in the basic function to which it is related. Accordingly, a value modified by a term or terms, such as “about” and “substantially” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The recitation of ranges of values herein are merely intended to serve as a shorthand method of referring individually to each separate value falling within the range, unless otherwise indicated herein, and each separate value is incorporated into the specification as if it were individually recited herein.

All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not impose a limitation on the scope of the invention unless otherwise claimed.

No language in the specification should be construed as indicating any nonclaimed element as essential to the practice of the invention.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

It will be apparent to those skilled in the art that various modifications and variations can be made to the present invention without departing from the spirit and scope of the invention. There is no intention to limit the invention to the specific form or forms disclosed, but on the contrary, the intention is to cover all modifications, alternative constructions, and equivalents falling within the spirit and scope of the invention, as defined in the appended claims. Thus, it is intended that the present invention cover the modifications and variations of this invention provided they come within the scope of the appended claims and their equivalents.

What is claimed is:

1. A wood chip collection system for use with a stump grinder having a stump grinding wheel used to break a tree stump into wood chips, comprising:
a. a chassis to which the stump grinder wheel is interconnected; and
b. a collection bin positioned adjacent to the chassis and having an open end that is adapted to receive chips therethrough.

2. The wood chip collection system according to claim 1, further comprising a rod extending between the collection bin and chassis and actuable to pivotally move the collection bin between a chip collection position and a chip dumping position.

3. The wood chip collection system according to claim 1, further comprising a chute connected to the chassis in spaced relation to the stump grinding wheel and having a trailing edge, the chute being positioned to receive wood chips as the stump grinding wheel impacts a tree stump.

4. The wood chip collection system according to claim 1, wherein the chute is pivotally connected to the chassis.

5. The wood chip collection system according to claim 1, wherein the collection bin is pivotally connected to the chassis.
